(19) United States
(12) Patent Application Publication
(10) Pub. No.: US 2026/0113678 A1
(43) Pub. Date: Apr. 23, 2026

(54) CELLULAR TELECOMMUNICATIONS NETWORK

(71) Applicant: BRITISH TELECOMMUNICATIONS PUBLIC LIMITED COMPANY, London (GB)

(72) Inventor: Salvador DIAZ SENDRA, London (GB)

(21) Appl. No.: 19/485,816

(22) PCT Filed: Apr. 9, 2024
(86) PCT No.: PCT/EP2024/059582

§ 371 Date: Nov. 19, 2025

(30) Foreign Application Priority Data
May 25, 2023 (EP) 23175434.2

(51) Int. Cl. H04W 36/00; H04W 48/18

(52) U.S. Cl. CPC H04W 36/13; H04W 48/18

(57) ABSTRACT

A method of operating a User Equipment (UE) in a cellular telecommunications network that implements a plurality of network slices can include determining a UE-specific probability of usage of each network slice of each network slice of the plurality of network slices based on an analysis of uplink data traffic; receiving a region-specific probability of usage of each network slice of the plurality of network slices, the region-specific probability of usage of each network slice being specific to a region in which the UE is positioned; modifying a network slice cell reselection priority for one or more network slices of the plurality of network slices based on the region-specific probability of usage of each network slice and further based on the UE-specific probability of usage of each network slice; and performing a cell reselection procedure based on the modified network slice cell reselection priority.

### PRIORITY CLAIM

The present application is a National Phase Entry of PCT Application No. PCT/EP2024/059582, filed Apr. 9, 2024, which claims priority from EP Application Serial No. 23175434.2, filed May 25, 2023, each of which is hereby fully incorporated herein by reference.

### TECHNICAL FIELD

The present disclosure relates to a cellular telecommunications network.

### BACKGROUND

Network slicing is a technique for creating differentiated logical networks on common infrastructure. It allows networking infrastructure to be optimized for a particular service, end-user or network operator by deploying specifically configured or tailored network functions on virtualized hardware, software-controlled networks and/or customized physical hardware. This may be performed for one or more network functions across one or more nodes in the network, including the access network, backhaul network and core network. In doing so, a collection of logical network functions (and the virtual network that connects them) may be grouped into a network slice which utilizes virtualized network functions, software-controlled networks and/or customized physical hardware on one or more nodes in the network. Each network slice may then be configured (e.g. by configuring each virtual function of the network slice) such that it is optimized for a particular use case. For example, in a cellular network, a first network slice for an autonomous vehicle application may be configured on one or more nodes in the cellular network to deliver an ultra-high reliability and ultra-low latency service, and further network slices configured for other applications may also be run on the same nodes through further virtual functions.

In the 3^{rd} Generation Partnership Project (3GPP) cellular telecommunications standards, a central network node (such as an Access and Mobility Management Function, AMF) may configure a User Equipment (UE) with a set of available network slices, wherein each network slice may be optimized for a particular use case. The UE may then select a network slice from this set of available network slices. A further concept of “slice specific cell reselection information” is proposed for inclusion in 3GPP Technical Specification 38.300. The slice specific cell reselection information may include reselection priorities per network slice per frequency and a corresponding list of cells where the network slices are supported or not supported. When a UE performs a cell reselection procedure, these reselection priorities may be used to influence cell selection or reselection.

### SUMMARY

According to a first aspect of the disclosure, there is provided a method of operating a User Equipment (UE) in a cellular telecommunications network, the cellular telecommunications network implementing a plurality of network slices, the method comprising: determining a UE-specific probability of usage of each network slice of each network slice of the plurality of network slices based on an analysis of uplink data traffic; receiving a region-specific probability of usage of each network slice of the plurality of network slices, the region-specific probability of usage of each network slice being specific to a region in which the UE is positioned; modifying a network slice cell reselection priority for one or more network slices of the plurality of network slices based on the region-specific probability of usage of each network slice and further based on the UE-specific probability of usage of each network slice; and performing a cell reselection procedure based on the modified network slice cell reselection priority.

According to a second aspect of the disclosure, there is provided a method of operating a device in a cellular telecommunications network, the cellular telecommunications network implementing a plurality of network slices, the method comprising': determining a region-specific probability of usage of each network slice of the plurality of network slices, the region-specific probability of usage of each network slice being specific to a region; and transmitting the region-specific probability of usage of each network slice to at least one UE in the region, wherein the region-specific probability of usage of each network slice is based on an analysis of one or more of a group comprising: downlink data traffic for a plurality of users in the region; a capability of the network slice in the region; subscription data of the plurality of users in the region; and a roaming agreement between network operators covering the region.

According to a third aspect of the disclosure, there is provided a computer program comprising instructions which, when the program is executed by a User Equipment, cause the User Equipment to carry out the method of the first aspect of the disclosure. The computer program may be stored on a computer readable carrier medium.

According to a fourth aspect of the disclosure, there is provided a computer program comprising instructions which, when the program is executed by a device, cause the device to carry out the method of the second aspect of the disclosure. The computer program may be stored on a computer readable carrier medium.

According to a fifth aspect of the disclosure, there is provided a User Equipment (UE) for a cellular telecommunications network comprising a processor configured to carry out the method of the first aspect of the disclosure.

According to a sixth aspect of the disclosure, there is provided a device for a cellular telecommunications network comprising a processor configured to carry out the method of the second aspect of the disclosure.

According to a seventh aspect of the disclosure, there is provided a system comprising the User Equipment (UE) of the fifth aspect of the disclosure and the device of the sixth aspect of the disclosure.

### BRIEF DESCRIPTION OF THE FIGURES

In order that the present disclosure may be better understood, embodiments thereof will now be described, by way of example only, with reference to the accompanying drawings in which:

FIG. 1 is a schematic diagram illustrating a cellular telecommunications network.

FIG. 2 is a flow diagram illustrating a process implemented by a network slice management node of the network of FIG. 1.

FIG. 3 is a flow diagram illustrating a process implemented by a base station of the network of FIG. 1.

FIG. 4 is a flow diagram illustrating a process implemented by a User Equipment of the network of FIG. 1.

### DETAILED DESCRIPTION

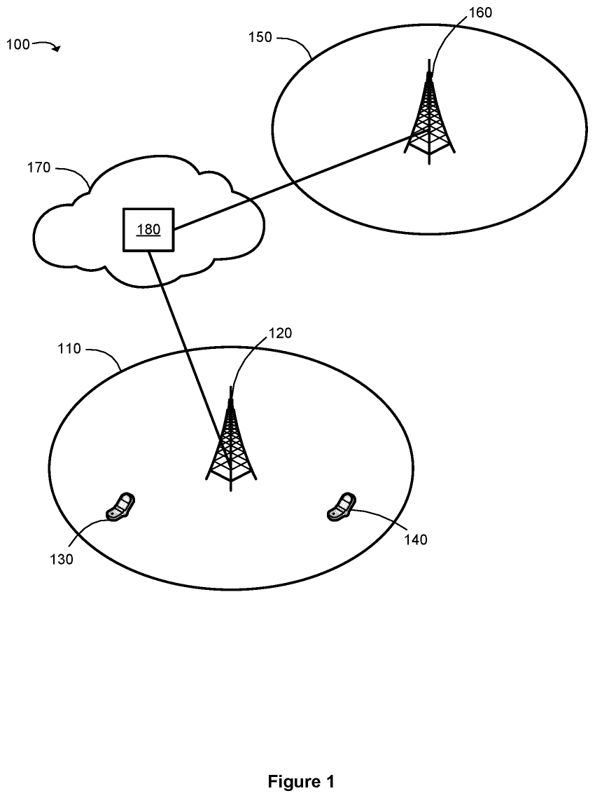

FIG. 1 illustrates a cellular telecommunications network 100 having a first tracking area 110 and a second tracking area 150. The first tracking area 110 includes a first base station 120, a first User Equipment (UE) 130 and a second UE 140. The second tracking area 150) includes a second base station 160. The first and second tracking areas 110, 150 may comprise more base stations and more UE than that shown in FIG. 1. FIG. 1 also illustrates a core network 170, which includes a network slice management node 180. The network slice management node 180 is connected to the first and second base stations 120, 160 via a suitable connection (e.g. wireless or wired connection).

The cellular telecommunications network is configured to implement network slicing. Accordingly, one or more nodes in the network (such as the first and second base stations 120, 160 and one or more nodes of the core network 170). may implement Network Function Virtualization (NFV) architectures such that virtual machines may be established on one or more of these network nodes and/or include dedicated physical hardware for a particular network slice. These virtual machines and/or dedicated physical hardware may then be tailored to a particular use case (such as for a particular service or a particular network operator) by suitable configuration. Each network slice in the network 100 is identifiable by a network slice identifier.

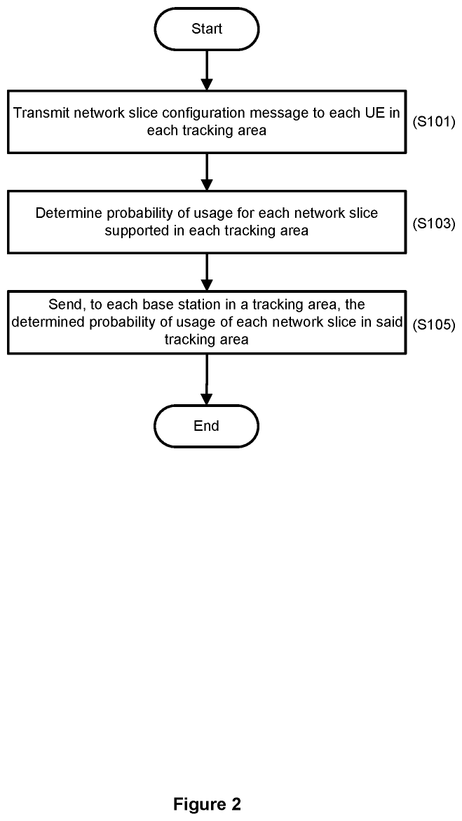

FIG. 2 is a flow diagram illustrating a process implemented by the network slice management node 180. In S101, the network slice management node 180 transmits a network slice configuration message to each UE in each tracking area (such as the first UE 130 and the second UE 140, and any other UE not shown in FIG. 1). The network slice configuration message is a Non-Access Stratum (NAS) message that is device specific and contains a set of network slice identifiers identifying each network slice available to that UE. The network slice configuration message also includes a cell reselection priority for each network slice identified in the set of network slice identifiers. These priorities may be used to influence cell selection or reselection, as described in 3^{rd} Generation Partnership Project (3GPP) Technical Specification 38.300.

In S103, the network slice management node 180 calculates a probability of usage for each network slice supported in each tracking area. The probability of usage for each network slice may be calculated based on one or more of:
Traffic analysis. The core network may store traffic patterns (e.g. in the Application Function (AF), Data Function (DF) and User Plane Function (UPF)), for each tracking area which may be analyzed to identify trends in traffic type. These trends may be identified over one or more timescales (such as hourly, daily or weekly timescales), and may be combined into a single metric representing multiple (optionally weighted) timescales. The probability of usage of a network slice in each tracking area may be based on these identified trends, such as a relatively high usage of traffic of a particular type in a repeating time window (e.g. between 9 AM and 5 PM every week day) may indicate that a network slice supporting such traffic may have a relatively high probability of usage in future instances of that repeating time window (compared to the probability of usage assigned to a network slice that supports a traffic type having relatively low usage in the data);
Hardware limitations. The core network may store capacity thresholds on the physical hardware (or virtual machine(s)) used by each network slice in the tracking area. These capacity thresholds may indicate, for example, the maximum number of users concurrently supported by the physical hardware or virtual machine(s), or may relate to a particular performance property, such as processing load, data rate, etc. If the current conditions of a network slice meet one or more of these capacity thresholds, then the probability of usage of that network slice may be limited (e.g. to zero);
Subscriptions. The core network may store subscription types of users in the tracking area, which may indicate if there is a relatively high demand for a traffic type associated with a particular network slice. For example, if the tracking area has a relatively high demand for autonomous vehicle traffic (determined from a subscription type of the users in the tracking area), then the network slice supporting such traffic may have a relatively high probability of usage (compared to the probability of usage assigned to a network slice that supports a traffic type having relatively low usage as determined by the subscription data);
Roaming. The core network may store roaming agreement data for each network slice, indicating whether the network slice is supported by the roaming partner operator. In an example, if it is determined, from the roaming agreement, that the roaming partner operator does not support a network slice, then the probability of usage of that network slice may be limited (e.g. to zero).

In S105, the network slice management node 180 sends the determined probability of usage of each network slice of the first tracking area to the first base station 120 (and any other base station in the first tracking area) and sends the determined probability of usage of each network slice of the second tracking area to the second base station 160 (and any other base station in the second tracking area).

S101 may be subsequently triggered following expiry of a timer or on detection of an event.

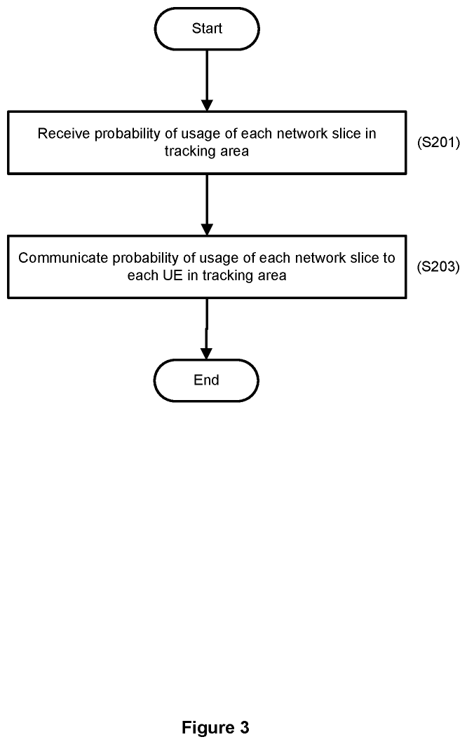

FIG. 3 illustrates a process implemented by the first base station 120. The following process may also be implemented by any other base station in the network 100. In S201, the first base station 120 receives the determined probability of usage of each network slice of the first tracking area (as sent in S105 of the process described with reference to FIG. 2). In S203, the first base station 120 communicates the probabilities of each network slice of the first tracking area to each UE in the first tracking area (such as the first UE 130 and second UE 140, and any other UE in the first tracking area). The form of communication depends on the status of the UE, and may include:
A System Information Block (SIB) message (or part thereof), such as a SIB 16 message, broadcast to any UE in IDLE of INACTIVE mode,
An RRCRelease message (or part thereof) for any UE transitioning from CONNECTED to IDLE mode,
An RRCSuspend message (or part thereof) for any UE transitioning from CONNECTED to INACTIVE mode, and
An RRCReconfiguration message (or part thereof) for any UE in CONNECTED mode, to be applied on subsequent transition to IDLE or INACTIVE mode.

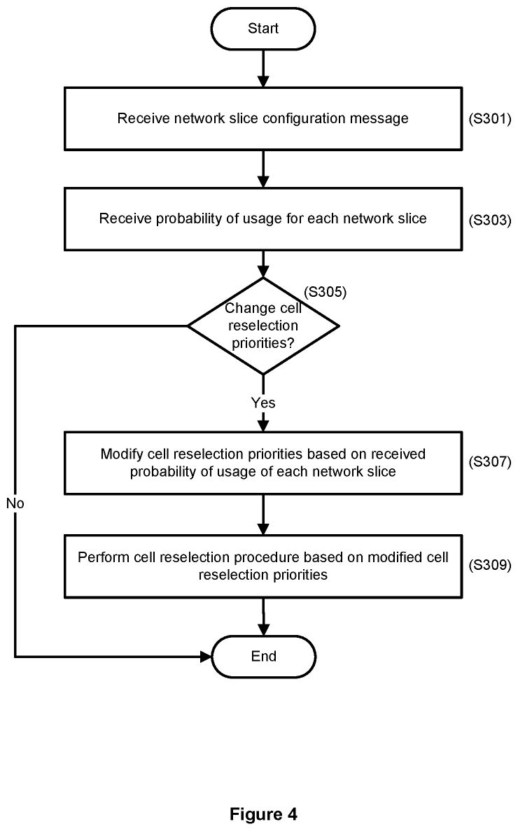

Turning to FIG. 4, which illustrates a process implemented by the first UE 130. The following process may also be implemented by any other UE in the network 100, such as the second UE 140. In S301, the first UE 130 receives the network slice configuration message (sent to the first UE 130 in S101 of the process described with reference to FIG. 2), which identifies the network slices available to the first UE 130 and their respective cell reselection priority. In S303, the first UE 130 receives the probabilities of usage of each network slice in the first tracking area (as sent in S203 of the process described with reference to FIG. 3). In S305, the first UE 130 determines whether a change to its cell reselection priorities should be implemented based on the received probabilities. This determination may be further based on data collected by the first UE 130, such as an analysis of uplink traffic data to calculate UE-specific probabilities of usage of each network slice.

S305 is further illustrated by the following example. Following S301 and S303, the first UE 130 stores the following data regarding the network slices available to the first UE 130:

TABLE 1
Table illustrating the identifiers, priorities and probabilities of
the network slices available to the first UE 130 following S303

| Network | Cell reselection | Tracking Area Network |
|---|---|---|
| Slice ID | Priority | Slice Probability |
| Slice_gaming | 7 | 10% |
| Slice_eMBB | 3 | 70% |
| Slice_bestEffort | 1 | 20% |

Applying S305 to this example, the first UE 130 may determine that the cell reselection priority should be updated as:

TABLE 2
Table illustrating the identifiers and priorities of the network
slices available to the first UE 130 following S305

| Network Slice ID | Cell reselection Priority |
|---|---|
| Slice_eMBB | 7 |
| Slice_gaming | 3 |
| Slice_bestEffort | 1 |

These priorities may be determined based on the tracking area specific probabilities as received in S303 (for example, the enhanced Mobile Broadband, eMBB, network slice may have the highest relative priority based on its relatively high probability of usage), and further based on data collected by the first UE 130 (for example, although the probability of usage of the best effort network slice is greater than the probability of usage of the gaming network slice, the first UE 130 may determine from an analysis of historical uplink traffic data that gaming traffic should be prioritized over best effort traffic, such that the gaming network slice may have a relatively higher priority than the best effort network slice).

If the first UE 130) determines that a change to its cell reselection priorities should be made then, in S307, the first UE 130) modifies its cell reselection priorities based on the probability of usage of each network slice in the first tracking area 110.

In S309, the first UE 130 performs a cell reselection process based on the modified cell reselection priorities. That is, the first UE 130 will preferentially attach to a cell that supports a network slice with a relatively high cell reselection priority.

The above processes therefore advantageously encourage the first UE 130 to 1) attach to a cell that supports the network slice that is more likely to be used by the first UE 130, and 2) connect to the network slice that is more likely to be used by the first UE 130. This reduces the amount of control signaling and associated energy consumption in the network 100) that would otherwise be realized if the first UE 130 connected to a cell that only supported network slices that are less likely to be used by the first UE 130 (which may result in the first UE 130 requesting a redirection to a suitable cell), and/or connecting to a network slice that is less likely to be used by the first UE 130 (which may result in the first UE 130 requesting a change in network slice). This further reduces the total time required for the first UE 130 to connect to a suitable cell and network slice.

The above processes also advantageously enable the first UE 130 to prioritize its cell reselection procedure based on information that is collected by the core network (including downlink traffic information) and information that is collected by the first UE 130) (including uplink traffic information).

The skilled person will understand that it is non-essential that a dedicated node (the network slice management node 180) implements the process shown in FIG. 2. That is, any other node of the core network may implement this process. Furthermore, one or more base stations may determine the probability of usage of each network slice, which may be implemented cooperatively (such that multiple base stations share data so as to calculate the probabilities), which are then communicated to each base station in the tracking area.

The skilled person will also understand that the network slice probabilities communicated to the UE may be determined over a different geographical region to the tracking area. For example, the region may be the coverage area or combined coverage area of one or more base stations in the network. However, the above example is consistent with network slicing implementations in which network slices are implemented across a tracking area.

It is also non-essential that the first UE 130 receives the initial network slice reselection priorities from an external node. That is, these priorities may be pre-configured on the first UE 130 (e.g. from an initial configuration of the first UE 130).

The skilled person will understand that any combination of features is possible within the scope of the disclosure, as claimed.

1. A method of operating a User Equipment (UE) in a cellular telecommunications network comprising a device and implementing a plurality of network slices, the method comprising:
determining a UE-specific probability of usage of each network slice of the plurality of network slices based on an analysis of uplink data traffic;
receiving, from the device, a region-specific probability of usage of each network slice of the plurality of network slices, the region-specific probability of usage of each network slice being specific to a region in which the UE is positioned;
modifying a network slice cell reselection priority for one or more network slices of the plurality of network slices based on the region-specific probability of usage of each network slice and further based on the UE-specific probability of usage of each network slice; and
performing a cell reselection procedure based on the modified network slice cell reselection priority.

2. A method of operating a device in a cellular telecommunications network implementing a plurality of network slices, the method comprising:
determining a region-specific probability of usage of each network slice of the plurality of network slices, the region-specific probability of usage of each network slice being specific to a region; and
transmitting the region-specific probability of usage of each network slice to at least one User Equipment (UE) in the region so as to enable the UE to modify a network slice cell reselection priority for one or more network slices of the plurality of network slices based on the region-specific probability of usage of each network slice, wherein the region-specific probability of usage of each network slice is based on an analysis of one or more of a group comprising:
downlink data traffic for a plurality of users in the region,
a capability of the network slice in the region,
subscription data of the plurality of users in the region, and
a roaming agreement between network operators covering the region.

3. A computer program comprising instructions which, when the program is executed by a User Equipment, cause the User Equipment to carry out the method of claim 1.

4. A computer program comprising instructions which, when the program is executed by a device, cause the device to carry out the method of claim 2.

5. A computer readable carrier medium comprising the computer program of claim 3.

6. A User Equipment (UE) for a cellular telecommunications network comprising a processor configured to carry out the method of claim 1.

7. A device for a cellular telecommunications network comprising a processor configured to carry out the method of claim 2.

8. A system comprising:
the User Equipment (UE) in the cellular telecommunications network implementing a plurality of network slices and comprising a processor configured to carry out the method of claim 1; and
a device for the cellular telecommunications network comprising a processor configured to:
determine a region-specific probability of usage of each network slice of the plurality of network slices, the region-specific probability of usage of each network slice being specific to a region; and
transmit the region-specific probability of usage of each network slice to at least one User Equipment (UE) in the region so as to enable the UE to modify a network slice cell reselection priority for one or more network slices of the plurality of network slices based on the region-specific probability of usage of each network slice, wherein the region-specific probability of usage of each network slice is based on an analysis of one or more of a group comprising:
downlink data traffic for a plurality of users in the region,
a capability of the network slice in the region,
subscription data of the plurality of users in the region, and
a roaming agreement between network operators covering the region.

9. A computer readable carrier medium comprising the computer program of claim 4.
